(19) United States
(12) Patent Application Publication
(10) Pub. No.: US 2002/0098261 A1
(43) Pub. Date: Jul. 25, 2002

(54) Die unit for injection molding

(75) Inventor: Jea-Hyok Joung, Suwon-City (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 09/883,952

(22) Filed: Jun. 20, 2001

(30) Foreign Application Priority Data
Jan. 19, 2001 (KR) 2001-3183

(51) Int. Cl. B29C 45/44

(52) U.S. Cl. 425/556; 425/438; 425/443; 425/418

(57) ABSTRACT

Disclosed herewith is a die unit for injection molding. The die unit includes first and second dies, which is selectively engaged with each other to form a mold cavity and disengaged from each other to remove a molded product. A first rotating member is rotatably attached to the first die, and provided at its central end surface with a first helical gear pattern. A second rotating member is rotatably attached to the second die, provided at its central end surface with a second helical gear pattern, and rotated in the same direction as the first rotating member while the molded product is removed.

### BACKGROUND OF THE INVENTION

1. Field of the Invention

The present invention relates generally to a die unit for injection molding, and more particularly to a die unit for injection molding that is used to manufacture casts having complicated shapes, such as combination helical gears.

2. Description of the Prior Art

In general, a die unit for injection molding is provided therein with a mold cavity that has a shape corresponding to the shape of a product. The die unit is comprised of a plurality of dies that can be separated from each other so as to allow a cast molded in the mold cavity to be removed therefrom.

In the process of separating an engaged die unit, a cast or part of the die unit may be rotated so as to allow a cast having a complicated shape, such as a helical gear, to be easily removed from the die unit.

However, a conventional die unit in which a cast is removed while being rotated requires a device for rotating the cast to be mounted thereon, so its structure is complicated and its manufacturing costs are high. Additionally, if the cast is a combination gear having a plurality of differently shaped gear portions, the cast cannot be rotated due to its different gear shapes, thereby hindering the cast from being removed from the die unit after being manufactured.

Unexamined Japanese Patent Publication 2000-167873 discloses an injection molding apparatus in which a part of a die unit is rotated and removed from the remaining part. In this die unit, its gear forming member is worn due to long-term use, so the gear forming member is undesirably moved, thereby causing a cast molded in the die unit to be off-center. Additionally, this apparatus has the problems that it is difficult to manufacture a combination helical gear due to the troubles in the centering and removal of the cast.

### SUMMARY OF THE INVENTION

Accordingly, the present invention has been made keeping in mind the above problems occurring in the prior art, and an object of the present invention is to provide a die unit for injection molding, which is capable of easily manufacturing combination helical gears each having differently shaped gear portions, and which is capable of easily removing molded combination helical gears therefrom.

In order to accomplish the above object, the present invention provides a die unit for injection molding, comprising: first and second dies selectively engaged with each other to form a mold cavity, and disengaged from each other to remove a molded product; a first rotating member rotatably attached to the first die, and provided at its central end surface with a first helical gear pattern; and a second rotating member rotatably attached to the second die, provided at its central end surface with a second helical gear pattern, and rotated in the same direction as the first rotating member while the molded product is removed.

The die unit may further comprise a first support member having an first tapered engaging protrusion, the first support member being attached to the first die; wherein the first rotating member is provided at its first die side surface with a first tapered engaging depression formed to be engaged with the first tapered engaging protrusion, and at its circumferential end surface with a second tapered engaging protrusion formed to be engaged with the second rotating member; and wherein the second rotating member is provided at its first die side surface with a second tapered engaging depression formed to be engaged with the second tapered engaging protrusion.

The die unit may further comprise a second support member for supporting the second rotating member while allowing it to be rotated.

The die unit may further comprise two holding rings, the holding rings being fixedly attached to the first and second support members so as to hold circumferential edges of the first and second rotating members while allowing the first and second rotating members to be rotated, respectively.

The die unit may further comprise bolt holes and bolts for facilitating engagement of the dies by preventing the first and second dies from being excessively spaced apart when the first and second dies are separated from each other, the bolt holes being formed through the first die, the bolts being slidably extended through the bolt holes, being secured to the second die and each having a slide portion longer than each of the bolt holes.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing a combination helical gear that is molded by a die unit for injection molding according to the present invention;

FIG. 2 is a cross section showing the injection molding die unit of the present invention with its dies engaged with one another;

FIG. 3 is a cross section showing the injection molding die unit of the present invention with its second die being disengaged from its third die;

FIG. 4 is a cross section showing the injection molding die unit of the present invention with its first die being disengaged from its second die; and

FIG. 5 is a cross section of the injection molding die unit of the present invention with a molded combination helical gear being removed from its dies.

### DESCRIPTION OF THE PREFERRED EMBODIMENTS

Reference now should be made to the drawings, in which the same reference numerals are used throughout the different drawings to designate the same or similar components.

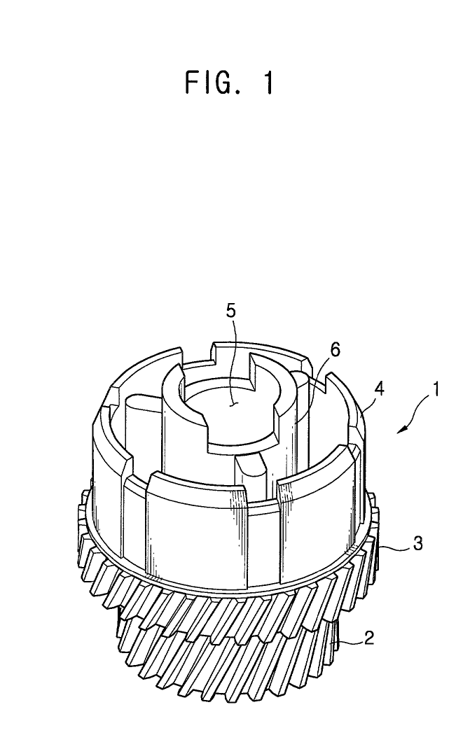

FIG. 1 is a perspective view showing a combination helical gear that is molded by a die unit for injection molding according to the present invention. As illustrated in the drawing, the molded combination helical gear 1 is provided with a first gear portion 2 and a second gear portion 3 that have different diameters. The combination helical gear 1 is further provided with a cylindrical extension 4 extended from the second gear portion 3, and a boss 6 provided with a bore 5 to allow a shaft to be fitted thereto.

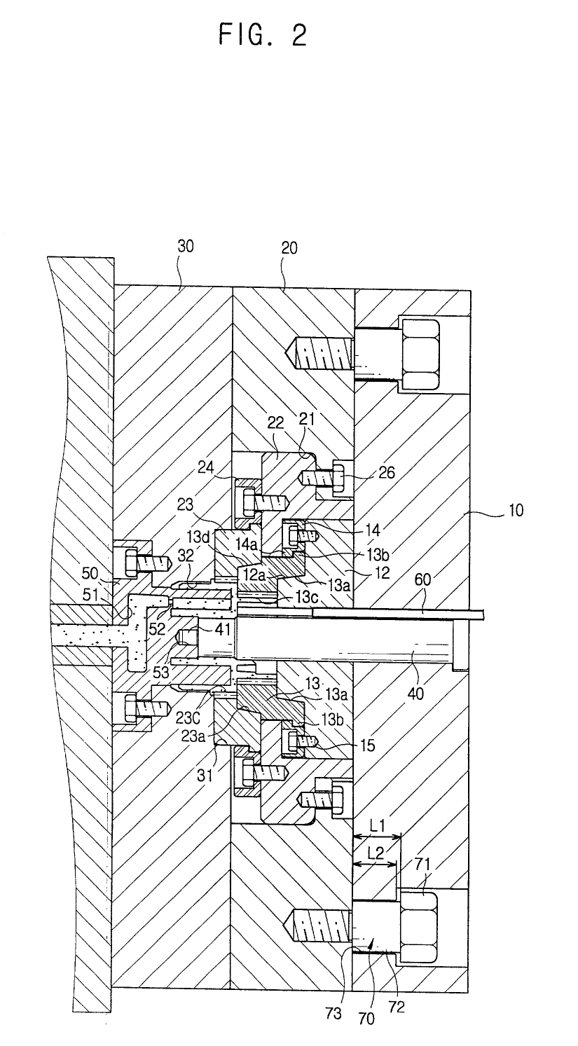

A die unit for molding the combination helical gear 1, as shown in FIG. 2, is provided therein with a mold cavity that is used to form the combination helical gear 1. The die unit includes first, second and third dies 10, 20 and 30 that can be engaged with and disengaged from one another.

A first rotating member 13 for forming the first gear portion 2 of the combination helical gear 1 and a first support member 12 for supporting the first rotating member 13 are attached to the first die 10, while a second rotating member 23 for forming the second gear portion 3 of the combination helical gear 1 and a second support member 22 for supporting the second rotating member 23 are attached to the second die 20. Hereinafter, the construction and engagement of the component parts of the die unit are described in detail.

A core 40 is inserted through the axial center portions of the first and second dies 10 and 20 and reaches the axial center portion of the third die 30 so as to form the center bore 5 of the combination helical gear 1. The first support member 12 provided with a first tapered engaging protrusion 12a is fixedly attached to the first die 10. The first support member 12 is secured closely to one side of the first die 10 while being fitted around the core 40. The first support member 12 is positioned in a center hole 21 formed in the second die 20.

The first rotating member 13 is rotatably engaged with the first engaging protrusion 12a of the first support member 12. To this end, a first tapered engaging depression 13a is formed on the first die side surface of the first rotating member 13 to be engaged with the first tapered engaging protrusion 12a. A first holding ring 14 is situated over the circumferential edge of the first rotating member 13 to keep the first rotating member 13 rotatably engaged with the first tapered engaging protrusion 12a. In order for the first holding ring 14 to hold the first rotating member 13 while allowing the first rotating member 13 to be rotated, two projections 14a and 13b are formed on the central end surface of the first holding ring 14 and the circumferential end surface of the first rotating member 13, respectively. The first holding ring 14 is secured to the first support member 12 by bolts 15. A first helical gear pattern 13c is formed on the central end surface of the first rotating member 13 to form the first gear portion 2 of the combination helical gear 1. A second tapered engaging protrusion 13d is formed on the third die side surface of the first rotating member 13.

The second support member 22 is situated over the circumferential edge of the first rotating member 13 to support a second rotating member 23. The central end surface of the second support member 22 is stepped, with its central end surface portion of a large diameter situated over the circumferential edges of the first support member 12 and the first holding ring 14, and with its central end surface portion of a small diameter situated over the circumferential edge of the first rotating member 13. The second support member 22 is fixedly attached to the second die 20 by a plurality of bolts 26 with the circumferential end surface of the second support member 22 stepped to correspond to the stepped central end surface 21 of the second die 20.

A second tapered engaging depression 23a is formed on one side of the second rotating member 23 to engage with the second tapered engaging protrusion 13d. A second holding ring 24 is situated over the circumferential edge of the second rotating member 23 to keep the second rotating member 23 rotatably engaged with the second tapered engaging protrusion 13d. The structure of the second holding ring 24 is the same as that of the first holding ring 14.

A second helical gear pattern 23c is formed on the radial end surface of the second rotating member 23 to form the second gear portion 3 of the combination helical gear 1. The second helical gear pattern 23c has an inner diameter larger than that of the first helical gear pattern 13c. The inclined direction of the teeth of the second rotating member 23 is the same as that of the first rotating member 13 so that the second rotating member 23 is rotated in the same direction as the first rotating member 13. A depression 31 is formed on one side of the third die 30 so as to accommodate and engage with a part of the second rotating member 23 when the dies 10, 20 and 30 are engaged with one another.

In such a case, the first tapered engaging protrusion 12a of the first support member 12, the first tapered engaging depression 13a and second tapered engaging protrusion 13d of the first rotating member 13, and the second tapered engaging depression 23a are tapered so that related parts are firmly engaged with one another and the centers of the first and second rotating members 13 and 23 coincide with the center of the core 40. Additionally, such a construction facilitates the separation of the dies 10 and 20, thus facilitating the rotation of the first and second rotating members 13 and 23.

An extension mold cavity 32 is formed in the third die 30 to form the extension 4 of the combination helical gear 1. A sprue bush 50 provided with a runner 51 and a gate 52 is mounted on the center portion of the third die 30 so as to guide molten resin into the mold cavity. A centering hole 53 is formed on the center of one side of the sprue bush 50, so as to receive a centering projection 41 formed on the front end of the core 40 so that the core 40 is engaged with the sprue bush 50 with the center of the core 40 coinciding with the center of the sprue bush 50. A rod-shaped ejector pin 50 extended through the first die 10 and the first support member 12 beside the core 40 is to be moved forward and rearward so as to push the molded combination helical gear 1 when the second die 30 is separated from the second die 20.

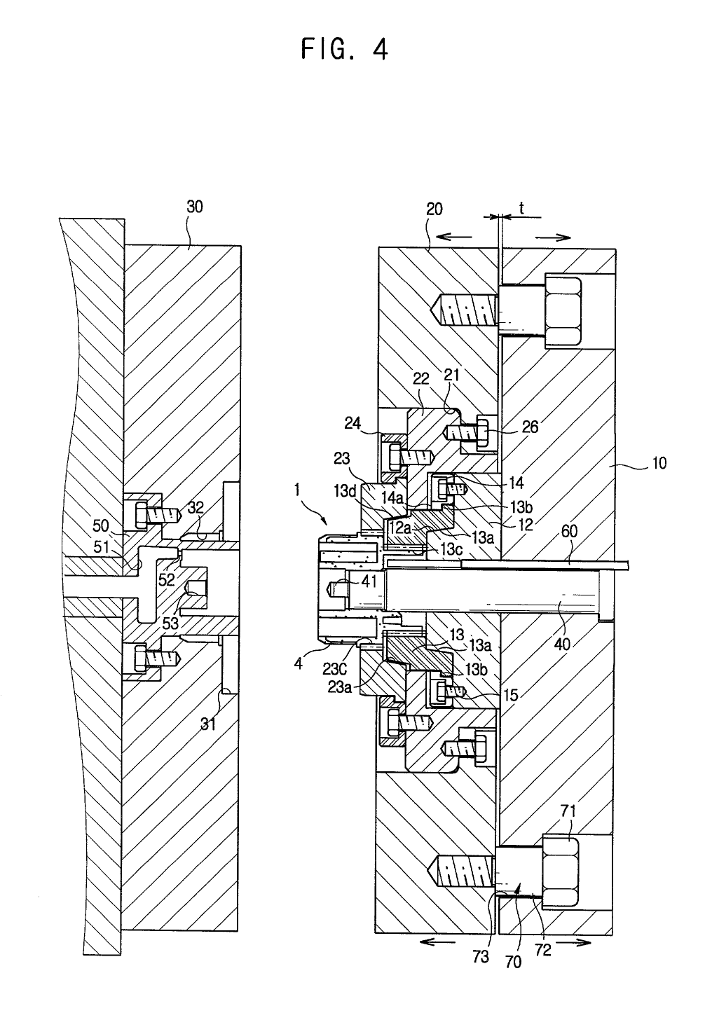

A plurality of bolts 70 are provided to connect the first and second dies 10 and 20, and allow the second die 20 to be slightly separated from the first die 10. In this case, the bolts 70 are slidably extended through the first die 10 and secured to the second die 20, and the heads 71 of the bolts 70 are held by the first die 10. The length L1 of the slide portion 72 of each bolt 70 is formed to be slightly larger than the length L2 of a bolt hole 73 formed in the first die 10. This is to prevent the first and second dies 10 and 20 from being excessively separated from each other, to allow the first and second rotating members 13 and 23 to be smoothly rotated, and to allow the first and second dies 10 and 20 to be easily engaged with each other, by allowing the first and second dies 10 and 20 to be slightly separated from each other (by the difference between the lengths L1 and L2) (see FIG. 4).

Hereinafter, the molding of the combination helical gear and the separation of the dies are described in connection with the die unit for injection molding according to the present invention.

When the first, second and third dies 10, 20 and 30 are engaged with one another, the outer surface of the core 40, the surface of the first helical gear pattern 13c of the first rotating member 13, the surface of the second helical gear pattern 23c of the second rotating member 23 and the wall of the extension mold cavity 32 of the third die 30 define the mold cavity for the combination helical gear 1. In this case, the first rotating member 13 is positioned by the first tapered engaging protrusion 12a and the first engaging depression 13a and the second rotating member 23 is positioned by the second tapered engaging protrusion 13d and the second tapered engaging depression 23a, so the centers of the first and second rotating members 13 and 23 coincide with the center of the core 40. In such a state, when molten resin supplied through the runner 51 and gate 52 of the sprue bush 50 fills the mold cavity, the molten resin is solidified, resulting in the formation of the combination helical gear 1.

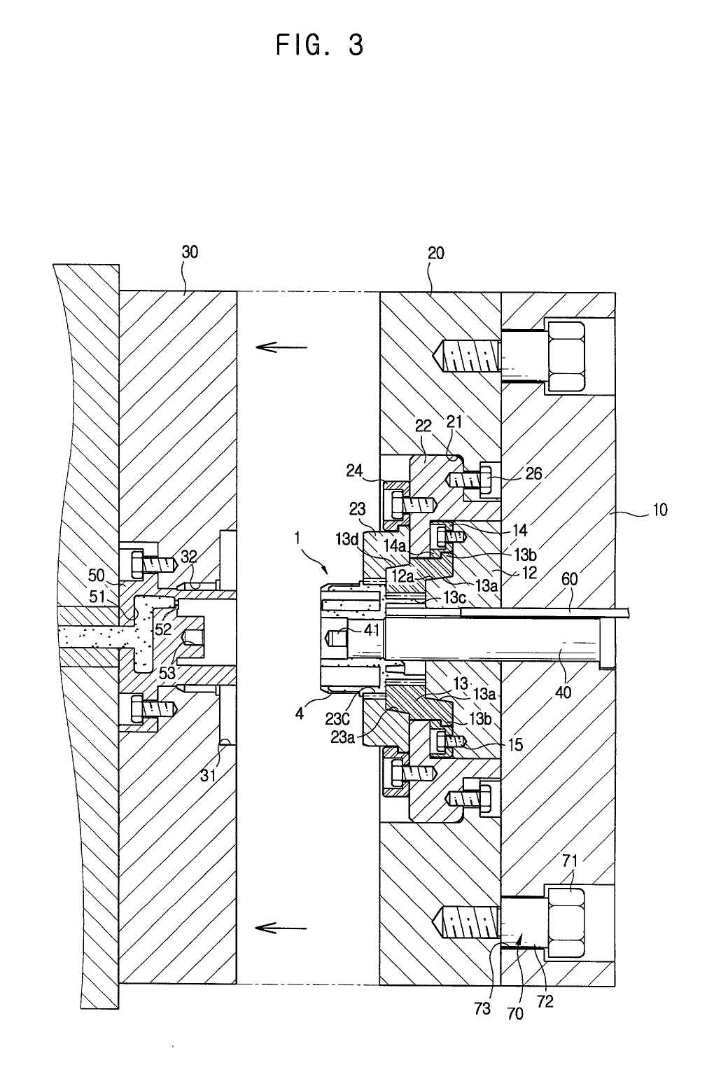

When the molded combination helical gear 1 is removed from the die unit, the third die 30, as shown in FIG. 3, is separated from the second die 20. At this time, the gate 52 connecting the combination helical gear 1 and the runner 51 is parted from the combination helical gear 1, and the extension 4 of the molded combination helical gear 1 is exposed to the outside.

As indicated in FIG. 4, when the second die 20 is separated from the first die 10 by a predetermined distance “t”, the second tapered engaging protrusion 13d of the first rotating member 13 is spaced apart from the second tapered engaging depression 23a of the second rotating member 23 to allow the second rotating member 23 to be rotatable, and the first tapered engaging depression 13a of the first rotating member 13 is spaced apart from the first tapered engaging protrusion 12a to allow the first rotating member 13 to be rotatable. In this case, the heads 71 of the bolts 70 connecting the first and second dies 10 and 20 are held by the first die 10, the spacing of the second die 20 from the first die 10 is restricted.

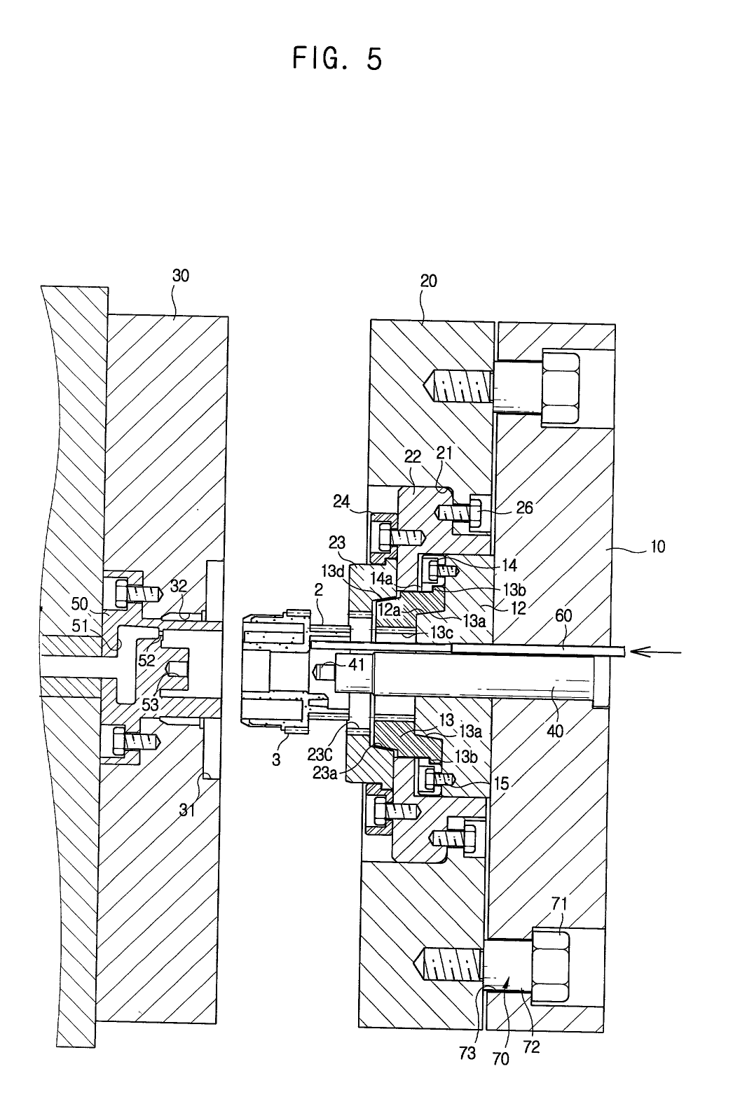

In this state, when the ejector pin 50, as depicted in FIG. 5, pushes the molded combination helical gear 1, the combination helical gear 1 is easily removed from the first and second dies 10 and 20 by the rotation of the first and second rotating members 13 and 23 in the same direction. That is, the first and second rotating members 13 and 23 are rotated in the same direction by the twisted teeth of the first and second gear portions 2 and 3 of the molded combination helical gear 1 while the mold combination helical gear 1 is pushed by the ejector pin 50 and removed toward the third die 30, so the molded combination helical gear 1 is easily removed from the first and second dies 10 and 20.

As described above, a die unit for injection molding in accordance with the present invention allows combination helical gears to be precisely centered and high quality combination helical gears to be manufactured because the centers of its first and second rotating members coincide with each other by the action of the engaging protrusions and depressions.

The die unit for injection molding in accordance with the present invention allows its first and second rotating members to be easily spaced apart from each other because they are engaged with each other by taper type engagement structures.

The die unit for injection molding in accordance with the present invention allows a molded combination helical gear to be easily removed therefrom because the first and second rotating members are rotated while the molded combination helical gear is separated from the dies.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A die unit for injection molding, comprising:
first and second dies selectively engaged with each other to form a mold cavity, and disengaged from each other to remove a molded product;
a first rotating member rotatably attached to said first die, and provided at its central end surface with a first helical gear pattern; and
a second rotating member rotatably attached to said second die, provided at its central end surface with a second helical gear pattern, and rotated in the same direction as said first rotating member while the molded product is removed.

2. The die unit according to claim 1, further comprising a first support member having an first tapered engaging protrusion, said first support member being attached to said first die;
wherein said first rotating member is provided at its first die side surface with a first tapered engaging depression formed to be engaged with said first tapered engaging protrusion, and at its circumferential end surface with a second tapered engaging protrusion formed to be engaged with said second rotating member; and
wherein said second rotating member is provided at its first die side surface with a second tapered engaging depression formed to be engaged with said second tapered engaging protrusion.

3. The die unit according to claim 2, further comprising a second support member for supporting said second rotating member while allowing it to be rotated.

4. The die unit according to claim 3, further comprising two holding rings, said holding rings being fixedly attached to said first and second support members so as to hold circumferential edges of said first and second rotating members while allowing said first and second rotating members to be rotated, respectively.

5. The die unit according to claim 1, further comprising bolt holes and bolts for facilitating engagement of said dies by preventing said first and second dies from being excessively spaced apart when said first and second dies are separated from each other, said bolt holes being formed through said first die, said bolts being slidably extended through said bolt holes, being secured to said second die and each having a slide portion longer than each of said bolt holes.
